(19) United States
(12) Patent Application Publication
(10) Pub. No.: US 2026/0313089 A1
(43) Pub. Date: Oct. 8, 2026

(54) ABNORMALITY DETECTION APPARATUS AND METHOD THEREOF

(71) Applicant: DENSO CORPORATION, Kariya-city (JP)

(72) Inventor: Ryo EMURA, Kariya-city (JP)

(21) Appl. No.: 19/630,616

(22) Filed: Mar. 27, 2026

(30) Foreign Application Priority Data
Apr. 4, 2025 (JP) 2025-062643

(51) Int. Cl. H04N 17/02; G06T 7/00; G06T 7/90

(52) U.S. Cl. CPC H04N 17/02; G06T 7/0002; G06T 7/90; G06T 2207/10016; G06T 2207/10024

(57) ABSTRACT

An abnormality detection apparatus is configured to cause an RGB color model video including a blinking dot to be displayed on a display screen of a display, identify a difference between the RGB values of video data to be displayed as the blinking dot and an expected value of the RGB values of the video data when there is no abnormality, and detect an abnormality in video display using the video data. The abnormality detection apparatus is configured to set the RGB values of the two specific colors of the blinking dot such that the difference between the RGB values of the two specific colors and RGB values of a background color displayed as a background on the display screen is equal to or less than a predetermined value.

### CROSS REFERENCE TO RELATED APPLICATION

This application is based on Japanese Patent Application No. 2025-062643 filed on Apr. 4, 2025, the disclosure of which is incorporated herein by reference.

### TECHNICAL FIELD

The present disclosure relates to an abnormality detection apparatus that detects abnormalities in video display.

### BACKGROUND

A related art discloses a technique for detecting whether a black-screen state, in which the entirety of a display unit becomes a black image, has continued for a predetermined time, by comparing, with a threshold, a summed value obtained by sampling RGB color signals supplied to the display unit a predetermined number of times.

### SUMMARY

According to an aspect of the present disclosure, an abnormality detection apparatus includes at least one of (i) a circuit and (ii) a processor with a memory storing computer program code executable by the processor. The at least one of the circuit and the processor may be configured to: cause an RGB color model video including a blinking dot, which is a pixel in which two specific colors having different RGB values are periodically switched, to be displayed on a display screen of a display; identify a difference between the RGB values of video data to be displayed as the blinking dot and an expected value of the RGB values of the video data when there is no abnormality; and detect an abnormality in video display using the video data when the identified difference is equal to or greater than a threshold value. The at least one of the circuit and the processor may be configured to set the RGB values of the two specific colors of the blinking dot such that the difference between the RGB values of the two specific colors and RGB values of a background color displayed as a background on the display screen is equal to or less than a predetermined value.

### BRIEF DESCRIPTION OF DRAWINGS

Objects, features and advantages of the present disclosure will become more apparent from the following detailed description made with reference to the accompanying drawings. In the drawings:

FIG. 1 is a diagram illustrating an example of a schematic configuration of a display apparatus;

FIG. 2 is a diagram for explaining an example of an output check unit;

FIG. 3 is an example illustrating a display screen of a display unit;

FIG. 4 is an example illustrating a display screen of a display unit; and

FIG. 5 is a diagram for explaining an example of a relationship among a background color, a first blinking color, and a second blinking color.

### DETAILED DESCRIPTION

In the technique described in the related art, since a summed value of RGB color signals is used, it could not detect display abnormalities such as image sticking (a stuck display) other than the black-screen state. It may be conceivable to detect a display abnormality by monitoring a blinking-dot video (image) signal that causes specific colors, such as red and green, to alternately blink on the display. In addition, in order to suppress a reduction in the marketability of the display due to the blinking dot being conspicuous, it may be conceivable to arrange the blinking dot in a portion that is hidden by a housing that covers an outer frame of the display. However, even with this measure, in a case where no housing that covers the outer frame of the display is provided due to an increase in the screen size of the display, the blinking dot may become conspicuous, which may reduce the marketability of the display.

The present disclosure provides an electronic control apparatus that makes it possible to suppress a reduction in the marketability of the display while enabling detection of a larger variety of display abnormalities.

According to one aspect of the present disclosure, an abnormality detection apparatus includes: a display control unit configured to cause an RGB color model video including a blinking dot, which is a pixel in which two specific colors having different RGB values are periodically switched, to be displayed on a display screen of a display; a data comparison unit configured to identify a difference between the RGB values of video data to be displayed as the blinking dot and an expected value of the RGB values of the video data when there is no abnormality; and an abnormality detection unit configured to detect an abnormality in video display using the video data when the difference identified by the data comparison unit is equal to or greater than a threshold value. The display control unit is configured to set the RGB values of the two specific colors of the blinking dot such that the difference between the RGB values of the two specific colors and RGB values of a background color displayed as a background on the display screen is equal to or less than a predetermined value.

With the above configuration, an abnormality in video display is detected from the difference between the RGB values of the video data to be displayed for the blinking dot, which is a pixel in which two specific colors having different RGB values are periodically switched, and the expected value expected as the RGB values of the video data when there is no abnormality. Therefore, it is also possible to detect display abnormalities such as image sticking of a video signal other than the black-screen state. In addition, since the RGB values of the two specific colors of the blinking dot are set such that the difference from the RGB values of the background color is equal to or less than the specified value, the hue of the blinking dot can be made close to the hue (color tone) of the background color. Accordingly, even when the blinking dot is not hidden by a housing of the display, it becomes less noticeable to a user, and the marketability of the display is less likely to be reduced. As a result, it is possible to suppress a reduction in the marketability of the display while enabling detection of a larger variety of display abnormalities.

Multiple embodiments for the present disclosure will be described with reference to the drawings. For convenience of explanation, among the multiple embodiments, components having the same functions as those shown in the drawings used in the preceding description may be assigned the same reference numerals and description thereof may be omitted. For components assigned the same reference numerals, description in other embodiments can be referred to.

### First Embodiment

### Schematic Configuration of Display Apparatus 1

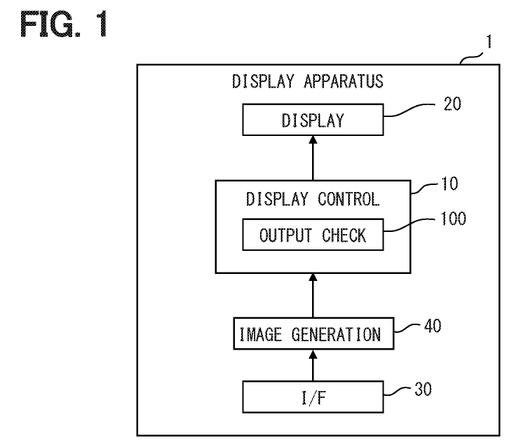

Hereinafter, first embodiment of the present disclosure will be described with reference to the drawings. A display apparatus 1 illustrated in FIG. 1 is usable in a vehicle. As illustrated in FIG. 1, the display apparatus 1 includes a display control unit 10, a display unit 20, an interface (I/F) unit 30, and an image generation unit 40. Each of these units may be implemented by hardware, software, or a combination thereof. The display apparatus 1 corresponds to a display. The display apparatus 1 is not limited to a configuration used in a vehicle; however, description will be given below by taking a case of use in a vehicle as an example. The vehicle using the display apparatus 1 is not necessarily limited to an automobile; however, description will be given below by taking a case of use in an automobile as an example.

The display unit 20 is a display panel that displays, on a display screen, an image indicated by video data input from the display control unit 10 described later. That is, the display unit 20 is a display panel that performs video display based on video data. For example, the display unit 20 may be a display panel provided in front of a driver’s seat in a cabin of the vehicle. That is, the display unit 20 may be a meter display panel. Alternatively, the display unit 20 may be a display panel of a CID (Center Information Display) arranged at the center of an instrument panel of the vehicle. The display unit 20 is capable of full-color display, and can be configured using, for example, a TFT liquid crystal display, an organic EL display, or the like. The following description will be given by taking, as an example, a case where the display unit 20 is a meter display panel.

The I/F unit 30 functions as an input/output interface for the display apparatus 1 to communicate with an in-vehicle ECU (may also be referred to as an vehicle onboard ECU). The I/F unit 30 acquires vehicle information from the in-vehicle ECU and sequentially outputs the vehicle information to the image generation unit 40.

Based on the vehicle information input from the I/F unit 30, the image generation unit 40 draws a meter image indicating various items of element information included in the vehicle information, and sequentially outputs video data thereof to the display control unit 10. The meter image may include text. The meter image corresponds to a video. Examples of the element information include vehicle speed, engine rotational speed, remaining fuel amount, engine coolant temperature, accumulated travel distance, shift position, turn indicator lever position, door lock state, seat belt wearing state, and light-on state. Abnormal states occurring in a powertrain (a drive system) and the like are also included in the element information. When a travel drive source of the vehicle is a motor, information such as a state of charge (a charge amount) corresponding to the motor may be used as the element information. The image generation unit 40 generates video data of the meter image to be displayed on the display unit 20 by arranging images for the respective pieces of element information on a background image in a predetermined layout. The background image is not necessarily limited to a single color; however, it may be a single color, for example.

The display control unit 10 is mainly configured as a computer including, for example, a processor, volatile memory, non-volatile memory, I/O, and a bus connecting these components. In the example of the present embodiment, description will be continued by taking, as an example, a case where the display control unit 10 is a microcontroller. Each of the image generation unit 40 and the display control unit 10 may be a functional block of one microcontroller, for example. The image generation unit 40 and the display control unit 10 may be implemented by different computers, respectively. The display control unit 10 implements various functions by executing a program stored in the non-volatile memory.

The display control unit 10 causes the image generation unit 40 to generate video data of the meter image. This video data is video data of a video in an RGB color model. In the example of the present embodiment, this video data is video data in RGB888 format. The display control unit 10 causes the display unit 20 to display video in an RGB color model, the video including a blinking-dot pixel that periodically alternates between two specific colors having different RGB values. The display control unit 10 may cause the image generation unit 40 to generate the meter image so as to include an image of the blinking dot in a portion of the meter image, thereby causing the RGB color model video including the blinking dot to be displayed. Hereinafter, one of the two specific colors of the blinking dot will be referred to as a first blinking color, and the other will be referred to as a second blinking color. The display control unit 10 may cause the RGB color model video including the blinking dot to be displayed by periodically switching the first blinking color and the second blinking color to be included in the meter image sequentially output by the image generation unit 40. Details of how the blinking dot is provided will be described later.

The display control unit 10 may also switch the meter image to be displayed on the display unit 20 in accordance with information received from an occupant via a user input device. The user input device may be an operation device that receives an operation input from a user. The operation device may be a mechanical switch or a touch switch integrated with the display unit 20. As one example, a steering switch provided on a steering wheel of the vehicle may be used as the user input device. The user input device is not limited to an operation device that receives an operation input, as long as it is a device that receives an input from a user. For example, the user input device may be a voice input device that receives an input of a voice command from a user. Examples of the input from the occupant include an input for switching a travel mode of the vehicle. Examples of the travel mode include a normal mode, an eco mode, a comfort mode, and a sport mode. The eco mode is a travel mode that prioritizes fuel economy or electric energy efficiency over a reference normal mode. The comfort mode is a travel mode that prioritizes ride comfort over the normal mode. The sport mode is a travel mode that prioritizes driving performance over the normal mode. The display control unit 10 switches the video displayed on the display unit 20 to a display mode corresponding to the selected travel mode. For example, when the travel mode is the sport mode, a display mode transition may be performed such that a video including a tachometer is displayed on the display unit 20, whereas in modes other than the sport mode, a video not including the tachometer is displayed.

As illustrated in FIG. 1, the display control unit 10 includes an output check unit 100 as a functional block. The output check unit 100 detects an abnormality in the displayed video (video display) output produced by the display unit 20. The output check unit 100 will be described in detail below.

### Schematic Configuration of Output Check Unit 100

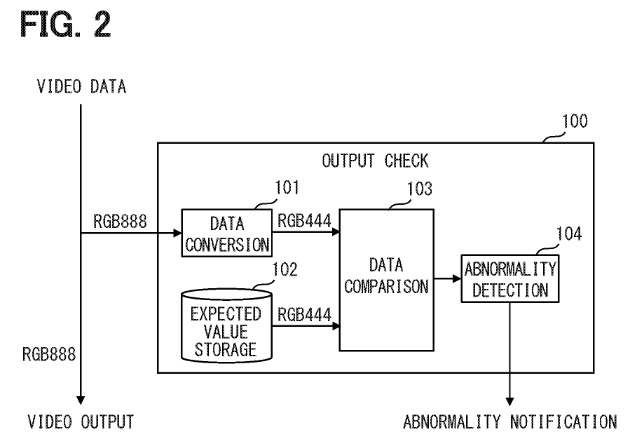

A schematic configuration of the output check unit 100 will be described with reference to FIG. 2. As illustrated in FIG. 2, the output check unit 100 includes, as functional blocks, a data conversion unit 101, an expected value storage unit 102, a data comparison unit 103, and an abnormality detection unit 104.

The data conversion unit 101 converts video data in RGB888 format output from the image generation unit 40 into data in RGB444 format. The data conversion unit 101 may be configured to convert only the blinking-dot data in the video data into RGB444-format data. Although the data conversion unit 101 does not necessarily need to perform this conversion for the blinking dot, it may be preferable to perform this conversion in order to reduce processing load in the subsequent data comparison unit 103 and the like. The video data in RGB888 format output from the image generation unit 40 is branched into (i) video data input to the data conversion unit 101 and (ii) video data output for display (video output).

The expected value storage unit 102 stores an expected value expected as RGB values of video data to be displayed as the blinking dot. When a configuration is adopted in which conversion into data in RGB444 format is performed by the data conversion unit 101, the RGB values as the expected value may be data in RGB444 format. As the expected value storage unit 102, a non-volatile memory may be used. The expected value is a value assumed when there is no abnormality in the video data output from the image generation unit 40. The expected value storage unit 102 stores in advance expected values expected for each of the first blinking color and the second blinking color of the blinking dot.

The data comparison unit 103 identifies a difference between RGB values of video data to be displayed as the blinking dot and an expected value expected as the RGB values of the video data when there is no abnormality. The RGB values of the video data to be displayed as the blinking dot are RGB values of video data actually output. The data comparison unit 103 identifies a difference between the RGB values of the blinking dot video data actually output and the expected value corresponding to the blinking dot stored in the expected value storage unit 102. At a scheduled timing at which the blinking dot is to be the first blinking color, the data comparison unit 103 may identify the difference between the RGB values of the blinking dot actually output and the expected value for the first blinking color. On the other hand, at a scheduled timing at which the blinking dot is to be the second blinking color, the data comparison unit 103 may identify the difference between the RGB values of the blinking dot actually output and the expected value for the second blinking color. The identified difference is then output to the abnormality detection unit 104. The data comparison unit 103 may determine the scheduled timings for the first blinking color and the second blinking color from information on the switching period for switching between the first blinking color and the second blinking color in the display control unit 10.

When the difference identified by the data comparison unit 103 is equal to or greater than a threshold, the abnormality detection unit 104 detects that there is an abnormality in video display based on the video data. The threshold may be any value as long as it is a value by which presence/absence of a video abnormality can be distinguished, and may be set arbitrarily. With this configuration, since an abnormality is detected based on whether the RGB values of the blinking dot are as expected, it becomes possible to detect display abnormalities such as a stuck image (may be referred to as display freeze, image sticking) other than the black-screen state. A stuck image refers to a state in which the displayed image does not change. When detecting that there is an abnormality in video display, the abnormality detection unit 104 may cause an abnormality notification to be issued. The abnormality notification may be performed by turning on a lamp or the like for notifying a video display abnormality, or by sounding a buzzer.

### How Blinking Dot Is Provided

Next, how the display control unit 10 provides the blinking dot will be described. As a setting, the display control unit 10 sets the RGB values of the first blinking color and the second blinking color of the blinking dot, such that a difference from the RGB values of a background color to be displayed as a background on the display screen is equal to or less than a predetermined value. With this configuration, since the RGB values of the first blinking color and the second blinking color of the blinking dot are set such that the difference from the RGB values of the background color is equal to or less than the predetermined value, it becomes possible to make the hue of the blinking dot close to the hue of the background color. Accordingly, even when the blinking dot is not hidden by a housing of the display apparatus 1, it becomes less noticeable to a user, and the marketability of the display apparatus 1 is less likely to be reduced. As a result, it is possible to suppress a reduction in the marketability of the display apparatus 1 while enabling detection of a larger variety of display abnormalities. This display control unit 10 corresponds to an abnormality detection apparatus.

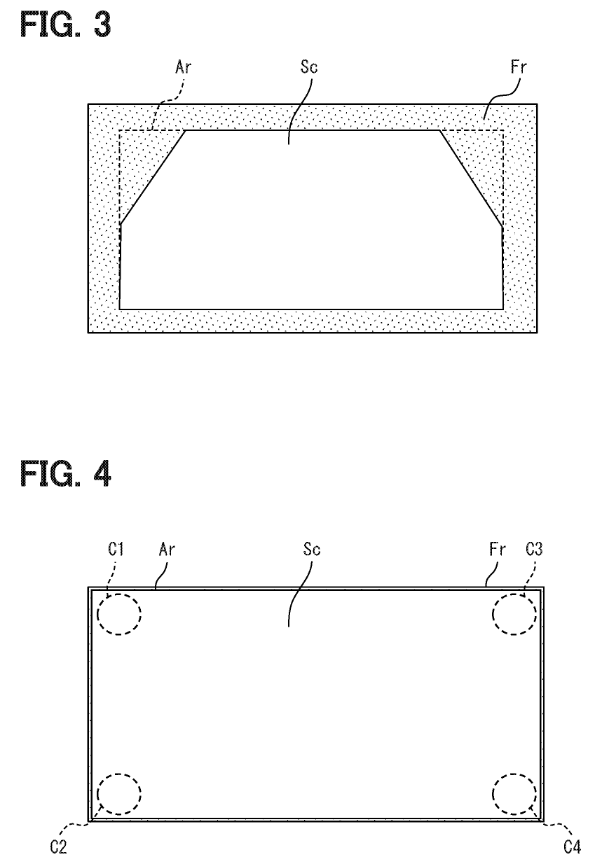

This effect will be described with reference to FIGS. 3 and 4. FIGS. 3 and 4 show examples of a display screen of the display unit 20. FIG. 3 shows an example in which the display screen is hidden by a frame surrounding the display screen. FIG. 4 shows an example in which the display screen is not hidden by the frame surrounding the display screen. The frame surrounding the display screen is also referred to as a bezel or the like, and is made of resin or the like. Fr in FIG. 3 and FIG. 4 indicates this frame. Sc in FIGS. 3 and 4 indicates the display screen. Ar in FIGS. 3 and 4 indicates an outer frame of a region of the display screen. As illustrated in FIG. 3, when the frame Fr covers and hides a portion of the display screen Sc, if the blinking dot is arranged in the portion hidden by the frame Fr, the blinking dot will not be noticed by the user. However, as illustrated in FIG. 4, when the frame Fr does not cover and hide the display screen Sc, it is not possible to arrange the blinking dot in a portion hidden by the frame Fr. In contrast, in the example of the present embodiment, even when the blinking dot is arranged in a portion not hidden by the frame Fr, it is possible to make the blinking dot less noticeable to the user. Therefore, while further increasing the size of the display screen of the display apparatus 1, it becomes possible to suppress a reduction in the marketability of the display apparatus 1 while enabling detection of a larger variety of display abnormalities.

When the background color to be displayed as a background on the display screen is black, it may be preferable that the display control unit 10 is configured to set the RGB values of the first blinking color and the second blinking color of the blinking dot such that, between the first blinking color and the second blinking color, only the B component differs. As used herein, "black" refers to RGB values (0, 0, 0) in RGB888 format. This is because experiments have clarified that, even when the background color changes from black, the switching between the first blinking color and the second blinking color is less recognizable to the human eye when the change is in the B component among RGB. Therefore, according to the above configuration, the blinking dot becomes even less noticeable to the user. As a result, it is possible to further suppress a reduction in the marketability of the display apparatus 1 while enabling detection of a larger variety of display abnormalities.

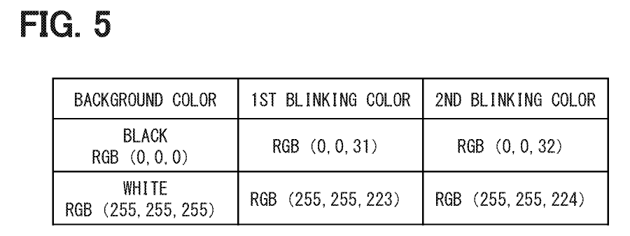

An example of setting the RGB values of the first blinking color and the second blinking color will be described. An example in which the background color is black will be described here. The background color being black here includes not only a case where the background color is fixed to black, but also a case where a default background color is black. In the example of the present embodiment, processing in the data comparison unit 103 is performed for RGB values in RGB444 format. Therefore, the first and second blinking colors are set to two colors that remain distinguishable after conversion to RGB444 format: one in which at least one of the RGB888 component values is in the range of 16 to 31, and another in which at least one of the RGB888 component values is in the range of 32 to 47. A value from 16 to 31 in RGB888 format becomes 1 in RGB444 format, and a value from 32 to 47 becomes 2 in RGB444 format. Further, in order to make blinking less recognizable even among a color corresponding to 16 to 31 and a color corresponding to 32 to 47, a color corresponding to 31 and a color corresponding to 32 are used. In addition, as described above, it may be preferable to set the values such that only the B value among RGB values differs; therefore, as illustrated in FIG. 5, the first blinking color is set to RGB values (0, 0, 31), and the second blinking color is set to RGB values (0, 0, 32). FIG. 5 is a diagram for explaining an example of a relationship among the background color, the first blinking color, and the second blinking color.

When the background color is white, the following may be performed, for example. The background color being white here includes not only a case where the background color is fixed to white, but also a case where a default background color is white. The white here refers to RGB values (255, 255, 255) in RGB888 format. Also when the background color is white, the setting may be made such that only the B value among RGB values differs. As illustrated in FIG. 5, the first blinking color may be set to RGB values (255, 255, 223), and the second blinking color may be set to RGB values (255, 255, 224). With this configuration, while enabling the RGB values of the first blinking color and the second blinking color to be distinguished even after conversion into RGB444 format, it is possible to make the blinking dot difficult for the human eye to recognize, that is, it is possible to make the blinking dot less noticeable to the human eye.

When the background color changes, it may be preferable that the display control unit 10 switches and sets the RGB values of the first blinking color and the second blinking color of the blinking dot, as configuration, in accordance with the background color. With this configuration, even when the background color changes, it is possible to display a blinking dot that is difficult for the human eye to recognize in accordance with the changing background color. As a result, it is possible to further suppress a reduction in the marketability of the display apparatus 1 while enabling detection of a larger variety of display abnormalities. To realize this configuration, for example, a background-color map of the first blinking color and the second blinking color for each of a plurality of types of background colors may be stored in a non-volatile memory, and the display control unit 10 may select and apply the corresponding first and second blinking colors in accordance with the change in the background color. Alternatively, a configuration may be adopted in which the expected value storage unit 102 stores the expected value for each background color, and the data comparison unit 103 uses the expected value in accordance with the background color.

It may be preferable that the display control unit 10 sets the switching period for switching between the first blinking color and the second blinking color of the blinking dot to be within a range from 1 millisecond to 600 seconds. If the switching period for switching between the first blinking color and the second blinking color becomes too short, the blinking dot tends to be noticed by the user, and/or software processing load increases. On the other hand, if the switching period for switching between the first blinking color and the second blinking color becomes too long, the blinking dot becomes less noticeable to the user, but responsiveness of abnormality notification decreases when an abnormality occurs in video display. In contrast, according to the above configuration, it is possible to prevent software processing load from increasing and to suppress a decrease in responsiveness until abnormality notification while making the blinking dot less noticeable to the user. It is more preferable that the display control unit 10 sets the switching period for switching between the first blinking color and the second blinking color of the blinking dot to be within a range from 0.5 seconds to 10 seconds. According to this, the above-described effects become greater.

It may be preferable that the display control unit 10 displays the blinking dot in, among regions closer to an edge than to the center of the display screen of the display apparatus 1, a region that is expected in advance to undergo little background-color change due to switching of video display. According to this, even when the background color greatly changes due to the above-described display mode transition, it becomes easier to make the blinking dot less noticeable to the user. For example, the region in which the blinking dot is displayed may be regions at the four corners of the display screen, as indicated by C1, C2, C3, and C4 in FIG. 4. As one example, the region in which the blinking dot is displayed may be an upper-left region among the four corners of the display screen, as indicated by C1 in FIG. 4.

### Second Embodiment

In the first embodiment, a configuration has been described in which the display control unit 10 is provided in the display apparatus 1; however, the present disclosure is not limited thereto. For example, an in-vehicle ECU that controls the display may be configured to perform at least part of the functions of the display control unit 10. In this case, the in-vehicle ECU also corresponds to an abnormality detection apparatus.

The present disclosure is not limited to the embodiments described above, and various modifications are possible within the scope set forth in the claims; embodiments obtained by appropriately combining technical means disclosed in different embodiments are also included in the technical scope of the present disclosure. Further, the control unit and its methods described in the present disclosure may be implemented by a dedicated computer including a processor programmed to execute one or more functions embodied in a computer program. Alternatively, the apparatus and the technique thereof described in the present disclosure may be implemented by a dedicated hardware logic circuit. Alternatively, the apparatus and the technique thereof described in the present disclosure may be implemented by one or more dedicated computers constituted by a combination of a processor that executes a computer program and one or more hardware logic circuits. The computer program may be stored, as instructions to be executed by a computer, in a computer-readable non-transitory tangible recording medium.

What is claimed is:

1. An abnormality detection apparatus comprising:
at least one of (i) a circuit and (ii) a processor with a memory storing computer program code executable by the processor, the at least one of the circuit and the processor configured to:
cause an RGB color model video including a blinking dot, which is a pixel in which two specific colors having different RGB values are periodically switched, to be displayed on a display screen of a display;
identify a difference between the RGB values of video data to be displayed as the blinking dot and an expected value of the RGB values of the video data when there is no abnormality; and
detect an abnormality in video display using the video data when the identified difference is equal to or greater than a threshold value,
wherein
the at least one of the circuit and the processor is further configured to set the RGB values of the two specific colors of the blinking dot such that the difference between the RGB values of the two specific colors and RGB values of a background color displayed as a background on the display screen is equal to or less than a predetermined value.

2. The abnormality detection apparatus according to claim 1, wherein
when the background color is black, the at least one of the circuit and the processor is configured to set the RGB values of the two specific colors of the blinking dot such that only B component differs between the RGB values of the two specific colors.

3. The abnormality detection apparatus according to claim 1, wherein
when the background color changes, the at least one of the circuit and the processor is configured to switch the RGB values of the two specific colors of the blinking dot in accordance with the background color.

4. The abnormality detection apparatus according to claim 1, wherein
the at least one of the circuit and the processor is configured to set a switching period between the two specific colors of the blinking dot to be within a range from 1 millisecond to 600 seconds.

5. The abnormality detection apparatus according to claim 1, wherein
the at least one of the circuit and the processor causes the blinking dot to be displayed in a region closer to an edge than to a center of the display screen, the region being estimated in advance to undergo little change in background color due to switching of the displayed video.

6. The abnormality detection apparatus according to claim 1, wherein
the at least one of the circuit and the processor is further configured to convert video data to be displayed as the blinking dot from RGB888 format to RGB444 format, and
the at least one of the circuit and the processor is configured to identify the difference between the RGB values of the converted video data of the blinking dot and the expected values corresponding to the RGB values.

7. The abnormality detection apparatus according to claim 6, wherein
the two specific colors of the blinking dot are a first blinking color and a second blinking color,
the abnormality detection apparatus further comprises an expected value storage that stores expected values, and
the expected value storage is a non-volatile memory and stores in advance an expected value for the first blinking color and an expected value for the second blinking color.

8. The abnormality detection apparatus according to claim 3, further comprising
a non-volatile memory storing a map of the two specific colors for each of a plurality of background colors,
wherein
the at least one of the circuit and the processor is configured to switch between and set the two specific colors based on the map in accordance with changes in the background color.

9. The abnormality detection apparatus according to claim 4, wherein
the at least one of the circuit and the processor is configured to set the switching period between the two specific colors of the blinking dot within a range of 0.5 seconds to 10 seconds.

10. The abnormality detection apparatus according to claim 5, wherein
the at least one of the circuit and the processor is configured to cause the blinking dot to be displayed in the region located at one of four corners of the display screen.

11. The abnormality detection apparatus according to claim 1, wherein
upon detecting the abnormality in the video display, the at least one of the circuit and the processor is configured to provide an abnormality notification by turning on a lamp or sounding a buzzer.

12. The abnormality detection apparatus according to claim 2, wherein
when the background color is black, one of the two specific colors of the blinking dot has a configured RGB value of (0, 0, 31), and the other has a configured RGB value of (0, 0, 32).

13. A method for detecting an abnormality in video display displayed on a display screen of a display, the method comprising:
setting RGB values of two specific colors to be used alternately as a blinking dot, such that a difference between the RGB values of the two specific colors and RGB values of a background color to be displayed as a background on the display screen is equal to or less than a specified value;
causing an RGB color model video including the blinking dot, the blinking dot being a pixel in which the two specific colors are periodically switched, to be displayed on the display screen of the display;
identifying a difference between RGB values of video data to be displayed as the blinking dot and an expected value expected as the RGB values of the video data when there is no abnormality; and
detecting that there is an abnormality in video display based on the video data when the difference is equal to or greater than a threshold.
